(19) United States
(12) Patent Application Publication
(10) Pub. No.: US 2010/0102278 A1
(43) Pub. Date: Apr. 29, 2010

(54) LOW TEMPERATURE WATER GAS SHIFT CATALYST

(75) Inventors: Rostam Jal Madon, Flemington, NJ (US); Peter Nagel, Highlands, NJ (US)

Correspondence Address: BASF CATALYSTS LLC, 100 CAMPUS DRIVE, FLORHAM PARK, NJ, 07932, US

(73) Assignee: BASF CATALYSTS LLC, Florham Park, NJ (US)

(21) Appl. No.: 12/650,110

(22) Filed: Dec. 30, 2009

Related U.S. Application Data
(62) Division of application No. 11/951,271, filed on Dec. 5, 2007.

(51) Int. Cl. C01B 3/16

(52) U.S. Cl. 252/373

(57) ABSTRACT

A low temperature water gas shift catalyst containing copper, zinc, aluminum in which the aluminum component is prepared from highly dispersible alumina as well as related methods are disclosed.

### CROSS-REFERENCE TO RELATED APPLICATIONS

This application is a Division of application Ser. No. 11/951,271 filed Dec. 5, 2007, the entire contents of which is hereby incorporated by reference.

### TECHNICAL FIELD

The present invention relates to a low temperature water gas shift (WGS) catalyst which may be used to convert CO and H₂O in a gas stream to CO₂ and H₂.

### BACKGROUND

Synthesis gas (syngas, a mixture of hydrogen gas and carbon monoxide) represents one of the most important feedstocks for the chemical industry. It is used to synthesize basic chemicals, such as methanol or aldehydes, as well as for the production of ammonia and pure hydrogen. However, synthesis gas produced by steam reforming of hydrocarbons is typically not suitable for some industrial applications because the syngas produced is relatively carbon monoxide rich and hydrogen poor.

In commercial operations, a water gas shift (WGS) reaction (Eq. 1) is used to convert carbon monoxide to carbon dioxide. An added benefit of the WGS reaction is that hydrogen is generated concurrently with the carbon monoxide conversion.

CO+H₂O [symbol] CO₂+H₂ Equation 1

The water gas shift reaction is usually carried out in two stages: a high temperature stage, with typical reaction temperatures of about 350 to 400° C., and a low temperature stage, with typical reaction temperatures of about 180 to 220° C. While the lower temperature reactions favor more complete carbon monoxide conversion, the higher temperature reactions allow recovery of the heat of reaction at a sufficient temperature level to generate high pressure steam. For maximum efficiency and economy of operation, many plants contain a high temperature reaction unit for bulk carbon monoxide conversion and heat recovery, and a low temperature reaction unit for final carbon monoxide conversion.

Catalytic compositions composed of mixtures of copper oxide and zinc oxide are used to promote the water gas shift reaction. Such catalysts may be prepared via co-precipitation of metal salts such as nitrate or acetate, thermal decomposition of metal complexes, or impregnation of metal salt onto a carrier. After preparation, the catalyst is washed to remove foreign ions, dried and calcined at an appropriate temperature to form oxides. The catalyst must then be reduced with hydrogen before use. After reduction, copper oxide in cupric form is reduced to metallic copper.

Alumina may be used as a carrier for a copper/zinc oxide water gas shift catalyst. Such catalysts may be prepared from a mixture of an aluminum salt, such as aluminum nitrate, sodium aluminate, or a combination thereof, with copper and zinc salts. Alumina may be mixed with the aluminum salts to provide a source of aluminum for the catalyst.

### SUMMARY

The following presents a simplified summary of the invention in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The present invention provides a water gas shift catalyst comprising from about 5 to about 75 weight % copper oxide, from about 5 to about 70 weight % zinc oxide, and from about 5 to about 50 weight % alumina. The catalyst is produced from a catalyst comprising copper and zinc compounds precipitated in the presence of dispersed alumina.

One aspect of the invention relates to a process for preparing a water gas shift catalyst from a dispersible alumina and precipitated copper and zinc compounds in which the dispersible alumina has 40% or greater dispersibility in water after peptizing at a pH from about 2 to about 5.

Yet another aspect of the invention relates to a reduced water gas shift catalyst prepared by reducing a water gas shift catalyst comprising from about 5 to about 75 weight % copper oxide, from about 5 to about 70 weight % zinc oxide, and from about 5 to about 50 weight % alumina prepared from a dispersible alumina and precipitated copper and zinc compounds in which the dispersible alumina has 40% or greater dispersibility in water after peptizing at a pH from about 2 to about 5. A hydrogen containing gas may be used as the reducing agent.

The invention comprises the features hereinafter fully described and particularly pointed out in the claims. The following description sets forth in detail certain illustrative aspects and implementations of the invention. These are indicative, however, of but a few of the various ways in which the principles of the invention may be employed. Other objects, advantages and novel features of the invention will become apparent from the following detailed description of the invention.

### DETAILED DESCRIPTION

### Definitions

The term “dispersible alumina” means an alumina which has 40% or greater dispersibility in water after peptizing at a pH of 2 to 5. Alumina having 50% or greater dispersibility, 60% or greater dispersibility, 70% or greater dispersibility, 80% or greater dispersibility, or 90% or greater dispersibility in water after peptizing at a pH of 2 to 5 are included in this definition.

The percent dispersibility of an alumina means the percentage of alumina that is less than 1 micron in size in the acidic solution after peptizing at a pH from about 2 to about 5.

The term “alkali metal carbonate” refers to LiHCO₃, Li₂CO₃, NaHCO₃, Na₂CO₃, KHCO₃, K₂CO₃, CsHCO₃, Cs₂CO₃, and mixtures thereof.

The term “psig” means pounds per square inch gauge, that is, the pressure referred to sea level atmospheric pressure as zero. It is the pressure on a sample above sea level atmospheric pressure.

Unless otherwise indicated in the following examples and elsewhere in the specification and claims, all parts and percentages are by weight, all temperatures are in degrees Centigrade, and pressure is at or near atmospheric pressure. With respect to any figure or numerical range for a given characteristic, a figure or a parameter from one range may be combined with another figure or a parameter from a different range for the same characteristic to generate a numerical range.

### DESCRIPTION

The present invention relates to a low temperature water gas shift catalyst comprising copper, zinc, aluminum. The catalyst comprises from about 5 to about 75 weight % cupric oxide, from about 5 to about 70 weight % zinc oxide, and from about 5 to about 50 weight % alumina.

The aluminum component of the catalyst of the present invention is prepared entirely from a dispersible alumina. The aluminum component is not prepared from an aluminum salt which is precipitated from solution as alumina. After peptizing at a pH from about 2 to about 5 a dispersible alumina which has 40% or greater dispersibility forms a suspension in which greater than 40% or more of the alumina particles in the suspension are less than 1 micron in size. It is preferred that larger percentages of alumina particles in the suspension are less than 1 micron in size. Aluminas that have 50% or greater dispersibility, 60% or greater dispersibility, 70% or greater dispersibility, 80% or greater dispersibility, or 90% or greater dispersibility, are preferred and are commercially available. A term such as “greater than 40% dispersibility” includes within its meaning the terms such as greater than 50% dispersibility up to greater than 90% dispersibility. The percentages of dispersibility stated above are meant to include all ranges within the broadly stated range.

The catalyst can be prepared in several acts. The reduced catalyst is prepared by reducing the water gas shift catalyst with a hydrogen containing gas.

### Forming A Dispersed Alumina Slurry

A dispersed alumina slurry is formed by peptizing a dispersible alumina in an acid solution at a pH from about 2 to about 5. In the peptizing process the dispersible alumina is added to water which is then acidified. Alternatively, the dispersible alumina is added to an acid solution. In either case a suspension in aqueous acid, between pH 2 and pH 5, having approximately 5 to about 35 wt % solids is formed. The preferred pH is about 3. The acid used to acidify the suspension may be a strong organic acid such as formic acid or a strong mineral acid such as nitric acid. The suspension is stirred in a high shear mixer for approximately 1 hour to form a slurry of dispersible alumina. Under these conditions greater than 40% of the alumina in the slurry is in the form of particles of 1 micron in diameter or less. The percentage of particles of 1 micron in diameter or less is higher for aluminas of higher dispersibility. Thus, for an alumina of 70% dispersibility 70% of the alumina would be in the form of particles of 1 micron in diameter or less.

The dispersible aluminas suitable for use in this invention are generally boehmite or pseudoboehmite aluminas which have 40% or greater dispersibility in water after peptizing at a pH from about 2 to about 5. Aluminas with greater than 70% or greater than 90% dispersibility in water after peptizing at a pH from about 2 to about 5 are preferred. Although a boehmite or pseudoboehmite alumina is most frequently used in the practice of this invention, any alumina which has 40% or greater dispersibility in water after peptizing at a pH from about 2 to about 5 may be used in the practice of the present invention. Dispersible boehmite or pseudoboehmite aluminas are commercially available. For example, Sasol supplies synthetic boehmite aluminas under the Disperal®, Dispal®, Pural®, and Catapal® trademarks.

### Adding The Alumina To The Copper and Zinc Salts

The slurry of dispersible alumina is added to a solution of copper and zinc salts such as nitrates, acetates, or a combination thereof. The mixture can be mixed for approximately 30 to about 60 minutes at a pH of approximately 3 to form a slurry comprising alumina, copper and zinc salts.

### Precipitation Of Copper and Zinc

The slurry comprising alumina, copper salts, and zinc salts is slowly added to a vessel containing a heal of water. Simultaneously an aqueous solution of an alkali metal carbonate is added to the vessel. A constant temperature is maintained from approximately 35° to about 90° C. The pH of the mixture in the vessel is maintained at pH 7 by adjusting the flow rate of the suspension of the slurry and the flow rate of the alkali metal carbonate. This results in the precipitation of insoluble copper and zinc compounds such as carbonates, mixed carbonates, and hydroxides, and thus a slurry containing these insoluble compounds in addition to alumina, is obtained. The slurry containing the precipitate is stirred and aged at a temperature of approximately 35° to about 90° C. for about 15 minutes to about 3 hours maintaining a pH of between 7 and 9.

### Formation Of The Catalyst

The precipitate is filtered, washed, and the powder is dried at temperature from about 80° C. to about 200° C. The precipitate is washed so that the Na₂O level is less than 0.2 wt % and preferably less than 0.1 wt %. The dried powder can be calcined for about 30 minutes to about 5 hours at temperature from about 200° C. to about 600° C. to obtain the catalyst. The calcined catalyst powder may then be formed into any size and shape such as tablets or pellets or extrudates as required for commercial use.

### Formation Of The Reduced Catalyst

The catalyst is reduced at about 100° C. to about 300° C. with a hydrogen containing gas to form the reduced water gas shift catalyst. During reduction, copper oxide in cupric form is reduced to metallic copper. Pure hydrogen may be used, or the hydrogen may be diluted with an inert gas such as nitrogen, helium, neon, argon, krypton or xenon. Syngas, a mixture containing hydrogen gas and carbon monoxide, is a convenient gas for reducing the catalyst.

The copper surface area of the reduced catalyst is important in the activity of the reduced catalyst. This Cu surface area is not the same as the total BET surface area, but instead must be measured separately. The activity of the reduced catalyst is measured by a test in which CO and H₂O are converted to CO₂ and H₂.

The following examples illustrate the subject invention.

### Example 1

### Catalyst Preparation

Two catalysts were prepared. Catalyst 1 and Catalyst 2 are examples of the present invention. A comparative catalyst, Catalyst 3, which is not an example of the present invention, was also prepared.

Catalyst 1 was prepared from 663.16 grams suspension of boehmite alumina, Catapal® B in water. The suspension contained 19% alumina expressed as Al₂O₃. The suspension was acidified to pH3 with nitric acid. The mixture was stirred in a high shear mixer for one hour to form a slurry of dispersed alumina. The dispersibility of the Catapal® B alumina was greater than 90%. The slurry of dispersed alumina was added to a solution containing 307.14 gram of copper nitrate and 151.85 grams of zinc nitrate to form a slurry containing alumina, copper nitrate, and zinc nitrate. This slurry was maintained at pH 3 and stirred for 60 minutes. The slurry containing alumina, copper nitrate, and zinc nitrate was slowly added to a vessel containing 2124.58 grams of water. Simultaneously, a solution containing 1433.3 grams of sodium carbonate solution was added. The flow rate of the sodium carbonate solution was adjusted so that the pH was controlled at pH 7. The temperature was maintained at 60° C. while the mixture was stirred and aged for 1.5 hours. The slurry was filtered, washed, and the powder was dried. The dried powder was calcined for 2 hours at 400° C. to form the catalyst.

Catalyst 2 was prepared in a similar manner except that Catapal® D was substituted for Catapal® B. The dispersibility of the Catapal® D alumina was greater than 90%.

Catalyst 3 was prepared from 1667.07 grams of an aluminum nitrate solution containing 4% Al. The aluminum nitrate was added to a solution containing 307.14 gram of copper nitrate and 151.85 grams of zinc nitrate. This solution was maintained at pH 3 and stirred for 60 minutes. The solution comprising aluminum nitrate, copper nitrate, and zinc nitrate was slowly added to a vessel containing 2124.58 grams of water. Simultaneously, a solution containing 1433.3 grams of sodium carbonate solution was added. The flow rate of the sodium carbonate solution was adjusted so that the pH was controlled at pH 7. The temperature was maintained at 60° C. while the mixture was stirred and aged for 1.5 hours. The slurry was filtered, washed, and the powder was dried. The dried powder was calcined for 2 hours at 400° C. to form the catalyst. The materials used in the preparation of the catalysts are summarized in Table 1. Table 2 gives the properties of the catalysts with the measured values for the components. Table 2 also provides data for the catalyst formed upon reduction of the catalyst.

TABLE 1

| | Example | | |
|---|---|---|---|
| | Catalyst 1 | Catalyst 2 | Catalyst 3 |
| Alumina source | Catapal B | Catapal D | Al Nitrate |
| Reagents (solutions) | | | |
| 17% as Copper in Nitrate solution, g | 1806.70 | 1806.70 | 1806.70 |
| 17% as Zinc in Nitrate solution, g | 893.21 | 893.21 | 893.21 |
| 4% as Al in Nitrate solution, g | NA | NA | 1667.07 |
| Al2O3 (at 19% solids) g | 663.16 | 663.16 | NA |
| Total wt of solution, g | 3363.07 | 3363.07 | 4366.98 |
| Water in mix, g | 1891.07 | 1891.07 | 2494.93 |
| % total metal conc. in solution | 27.80 | 27.80 | 21.07 |
| Water for required conc., g | 5256.68 | 5256.68 | 5256.68 |
| Water to be added for dilution, g | 3365.60 | 3365.60 | 2761.75 |
| Sodium Carbonate g | 1433.3 | 1433.3 | 1433.3 |
| Water g | 4538.9 | 4538.9 | 4538.9 |
| Total carbonate solution prepared | 5972.2 | 5972.2 | 5972.2 |
| Water Heel g | 2124.58 | 2124.58 | 2124.59 |
| Hold time (min) | 90 | 90 | 90 |
| Stirrer rpm | 2000 | 2000 | 2000 |
| Grams of metal in final catalyst | | | |
| g Cu | 307.14 | 307.14 | 307.14 |
| g Zn | 151.85 | 151.85 | 151.85 |
| g Al from nitrate | NA | NA | 66.68 |
| g Al from solid alumina | 66.68 | 66.68 | NA |
| Total g of metal | 525.67 | 525.67 | 525.67 |

TABLE 2

| | Example | | |
|---|---|---|---|
| Analysis | Catalyst 1 | Catalyst 2 | Catalyst 3 |
| % CuO | 50.58 | 53.2 | 53.13 |
| % ZnO | 29.61 | 27.84 | 27.17 |
| % Al₂O₃ | 19.71 | 18.87 | 19.61 |
| % Na₂O | 0.10 | 0.09 | 0.08 |
| CuO/ZnO | 1.71 | 1.91 | 1.96 |
| BET total surface area, m²/g | 106 | 99 | 85 |
| Pore volume (via N₂) in 2 to | 0.482 | 0.571 | 0.277 |
| 50 nm range, m³/g | | | |
| | Reduced | Reduced | Reduced |
| After reduction | Catalyst 1 | Catalyst 2 | Catalyst 3 |
| % Cu | 45.0 | 47.6 | 47.5 |
| % ZnO | 33.0 | 31.2 | 30.4 |
| % Al₂O₃ | 21.9 | 21.1 | 22.0 |
| % Na₂O | 0.1 | 0.10 | 0.1 |
| Cu/ZnO | 1.36 | 1.53 | 1.56 |
| Cu surface area, m²/g | 18.7 | 19.1 | 10.7 |

### Example 2

### Measurement of the Copper Surface Area

The Cu surface areas of reduced Catalyst 1, reduced Catalyst 2, and reduced Catalyst 3 prepared in Example 1 were measured by a standard procedure described by G. C. Chinchen et al. in Journal of Catalysis (1987), vol 103, pages 79 to 86. The catalyst is first reduced at approximately 210° C. using a gas containing 5% hydrogen in nitrogen. A reduced metallic Cu surface is obtained. A gas containing 2 wt % N₂O in helium at 60° C. is allowed to flow through the reduced catalyst for 10 minutes. Nitrous oxide decomposes on the copper surface of the catalyst, the resulting N₂ evolved is measured via a thermal conductivity detector, and the oxygen atoms remain attached to the copper. Each oxygen atom is attached to 2 surface Cu atoms. The amount of nitrogen evolved gives a measure of the number of number of oxygen atoms, and thus copper atoms available on the surface of the catalyst. The surface area of a Cu atom is 6.8×10⁻¹⁶ cm²/atom. By multiplying the number of Cu atoms by the area of each atom the copper surface area of the catalyst is derived. The results shown in Table 2 show that although the composition of Catalyst 1, Catalyst 2, and catalyst 3 are very similar, Catalyst 1 and Catalyst 2 have much larger copper surface areas.

### Example 3

### Measurement of Catalyst Activity

Catalyst 1, Catalyst 2, and Catalyst 3 were reduced at 170° C. by treatment with He containing 3 mol % hydrogen for 1 h, 5 mol % hydrogen for 2 h, and 20 mol % hydrogen for 1 h. The temperature was raised to 200° C. and the catalyst was further treated with He containing 20 mol % hydrogen for 1 h.

Catalyst activity tests were carried out on the reduced catalysts. The tests of the reduced catalyst were conducted in a fixed bed reactor at 200° C., 25 psig total pressure. The particle sizes of all catalysts used were between 50 and 100 mesh. The gas passed over the catalyst contained 12 mol % CO, 8 mol % CO₂, 55 mol % H₂, and 25 mol % N₂; the steam/dry gas mol ratio was 0.5. Each reduced catalyst was run at various space-velocities, and the rate of reaction was obtained for each catalyst at 40% CO conversion. This conversion is far from the thermodynamic equilibrium of the reaction thus giving a reaction rate to compare.

Table 3 shows the rates of reaction at 40% CO conversion. The rates are given as mole of CO reacted per gram of catalyst per hour (Rate A) and as mole of CO reacted per total moles of Cu (as metal) per hour (Rate B). In both cases, the rates of the catalyst for the current invention, reduced Catalysts 1 and 2, prepared from dispersible aluminas are more than 40% higher than the comparative example reduced Catalyst 3, prepared from aluminum nitrate.

TABLE 3

| | | Rate B |
|---|---|---|
| | Rate A | mol CO/mol |
| Sample Id. | mol CO/g · h | Cu · h |
| Reduced Catalyst 1 | 24.5 × 10⁻² | 33.9 |
| Reduced Catalyst 2 | 24.3 × 10⁻² | 32.4 |
| Reduced Catalyst 3 | 16.9 × 10⁻² | 22.5 |

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. A method of converting carbon monoxide and water in a gas to carbon dioxide and hydrogen, comprising:
contacting a gas comprising carbon monoxide and water with a water gas shift catalyst to convert carbon monoxide and water in the gas to carbon dioxide and hydrogen, the water gas shift catalyst comprising from about 5 to about 75 weight % copper oxide, from about 5 to about 70 weight % zinc oxide, and from about 5 to about 50 weight % alumina component prepared from a dispersible alumina in which the dispersible alumina has 40% or greater dispersibility in water after peptizing at a pH from about 2 to about 5, wherein the alumina component is not prepared from an aluminum salt.

2. The method of claim 1, the alumina component is prepared from a dispersible alumina having a percent dispersibility of 50% or greater in water after peptizing at a pH of 2 to 5.

3. The method of claim 1, the alumina component is prepared from a dispersible alumina having a percent dispersibility of 60% or greater in water after peptizing at a pH of 2 to 5.

4. The method of claim 1, the alumina component is prepared from a dispersible alumina having a percent dispersibility of 70% or greater in water after peptizing at a pH of 2 to 5.

5. The method of claim 1, the alumina component is prepared from a dispersible alumina having a percent dispersibility of 80% or greater in water after peptizing at a pH of 2 to 5.

6. The method of claim 1, the alumina component is prepared from a dispersible alumina having a percent dispersibility of 90% or greater in water after peptizing at a pH of 2 to 5.

7. The method of claim 1, wherein the dispersible alumina is selected from the group consisting of boehmite alumina, pseudoboehmite alumina, and mixtures thereof.

8. The method of claim 1, wherein the dispersible alumina comprises boehmite alumina.

9. The method of claim 1, wherein the dispersible alumina comprises pseudoboehmite alumina.

10. The method of claim 1, wherein the alumina component is prepared entirely from the dispersible alumina.

11. A method of converting carbon monoxide and water in a gas to carbon dioxide and hydrogen, comprising:
contacting a gas comprising carbon monoxide and water with a reduced water gas shift catalyst to convert carbon monoxide and water in the gas to carbon dioxide and hydrogen, the reduced water gas shift catalyst prepared from a water gas shift catalyst comprising from about 5 to about 75 weight % copper oxide, from about 5 to about 70 weight % zinc oxide, and from about 5 to about 50 weight % alumina in which the water gas shift catalyst is prepared from a dispersible alumina having a percent dispersibility of 40% or greater in water after peptizing at a pH from about 2 to about 5, wherein the gas shift catalyst is not prepared from an aluminum salt.

12. The method of claim 11, wherein the reduced water gas shift catalyst is prepared from a dispersible alumina having a percent dispersibility of 50% or greater in water after peptizing at a pH of 2 to 5.

13. The method of claim 11, wherein the reduced water gas shift catalyst is prepared from a dispersible alumina having a percent dispersibility of 60% or greater in water after peptizing at a pH of 2 to 5.

14. The method of claim 11, wherein the reduced water gas shift catalyst is prepared from a dispersible alumina having a percent dispersibility of 70% or greater in water after peptizing at a pH of 2 to 5.

15. The method of claim 11, wherein the reduced water gas shift catalyst is prepared from a dispersible alumina having a percent dispersibility of 80% or greater in water after peptizing at a pH of 2 to 5.

16. The method of claim 11, wherein the reduced water gas shift catalyst is prepared from a dispersible alumina having a percent dispersibility of 90% or greater in water after peptizing at a pH of 2 to 5.

17. The method of claim 11, wherein the dispersible alumina is selected from the group consisting of boehmite alumina, pseudoboehmite alumina, and mixtures thereof.

18. The method of claim 11, wherein the dispersible alumina comprises a boehmite alumina.

19. The method of claim 11, wherein the dispersible alumina comprises a pseudoboehmite alumina.

20. The method of claim 11, wherein the alumina component is prepared entirely from the dispersible alumina.
